(19) United States
(12) Patent Application Publication
(10) Pub. No.: US 2018/0279562 A1
(43) Pub. Date: Oct. 4, 2018

(54) PLANTING CUP AND PLANTING DEVICE

(71) Applicant: CHIN-WEI LIN, Hsinchu County (TW)

(72) Inventor: CHIN-WEI LIN, Hsinchu County (TW)

(21) Appl. No.: 15/475,381

(22) Filed: Mar. 31, 2017

(51) Int. Cl. A01G 9/10; A01G 9/02

(52) U.S. Cl. CPC A01G 9/1066; A01G 9/02

(57) ABSTRACT

A planting cup and a planting device are provided. The planting cup is a hollow cup body. The planting cup has a side portion and a bottom portion each formed with a plurality of through holes. A top portion of the planting cup is formed with a first wing extending laterally outwardly. The side portion is formed with a second wing extending laterally outwardly. The first wing is spaced from the second wing by a distance. When the planting cup is disposed on a planting tray to form the planting device, the second wing leans against the planting tray. The first wing is adapted for grasping by a mechanical device or by manpower, such that the planting cup can be removed conveniently.

### FIELD OF THE INVENTION

The present invention relates to a planting cup and a planting device, and more particularly to a planting cup having two wings and a planting device using the planning cup. Through the two wings, the planting cup can be conveniently grasped by a mechanical device or manually.

### BACKGROUND OF THE INVENTION

In recent years, because the economic structural changes, agricultural production is facing the problems of labor shortage, wage rise, and small scale of operation. As a result, the production cost cannot be reduced. Due to the improvement of living standards, the agricultural production tends to specialization and division of labor. The farmers require higher quality of seedlings, so there is a tendency that farmers buy planting trays (also known as a planting structure) from the nursery center for seedling growth.

A planting tray is used to cultivate seedlings, which can separate the seedlings in independent cavities of the planting tray to achieve the effects of rapid grow and stable quality. The greatest advantage of using a planting tray to cultivate seedlings is that the cultivation can be a mass scale or in batches to save the time of cultivation.

An improved planting device comprises a movable planting cup used for planting and a planting tray having a plurality of planting cavities. When the planting device is provided with soil and seeds, the planting cup is placed in the planting cavity of the planting tray for cultivation of seedling. However, the conventional planting cup has only one wing. When the planting cup is placed in the planting cavity of the planting tray, the top of the planting cup is almost attached to the top surface of the planting tray. It is difficult and inconvenient to remove the planting cup from the planting tray to another planting tray for cultivation when the stage of seedling is over. So far, the operation is done manually, which is time-consuming and labor-consuming. Accordingly, the inventor of the present invention has devoted himself based on his many years of practical experiences to solve these problems.

### SUMMARY OF THE INVENTION

In view of the problems of the prior art, the primary object of the present invention is to provide a planting cup having two wings and a planting device using the planting cup. Through the two wings, the planting cup can be conveniently grasped by a mechanical device or manually.

According to one aspect of the present invention, a planting cup is provided. The planting cup comprises a side portion, a bottom portion, a top portion, and an accommodation space surrounded by the side portion, the bottom portion, and the top portion. The bottom portion and the side portion each have a plurality of through holes. The top portion is formed with a first wing extending laterally outwardly. The side portion is formed with a second wing extending laterally outwardly. The first wing is spaced from the second wing by a distance.

Preferably, the side portion, the bottom portion, the first wing and the second wing are integrally formed.

Preferably, the side portion is provided with a plurality of first through holes between the first wing and the second wing. The side portion is provided with a plurality of second through holes between the second wing and the bottom portion. The number or the total area of the first through holes is equal to the number or the total area of the second through holes.

Alternatively, the side portion is provided with a plurality of first through holes between the first wing and the second wing. The side portion is provided with a plurality of second through holes between the second wing and the bottom portion. The number or the total area of the first through holes is greater than the number or the total area of the second through holes.

Preferably, the cross-sectional area of an upper half of the side portion is equal to the cross-sectional area of a lower half of the side portion.

Alternatively, the cross-sectional area of an upper half of the side portion is greater than the cross-sectional area of a lower half of the side portion.

Preferably, the planting cup is one of a hollow cylinder and a hollow cuboid.

Preferably, the side portion is provided with a plurality of first through holes between the first wing and the second wing. The side portion is provided with a plurality of second through holes between the second wing and the bottom portion. The number of the first through holes is greater than the number of the second through holes. The planting cup is one of a hollow cylinder and a hollow cuboid.

According to another aspect of the present invention, a planting device is provided. The cutting device comprises at least one aforesaid planting cup and a planting tray. The planting tray has a plurality of spaced cavities penetrating a top surface and a bottom surface of the planting tray. The planting cup is placed in one of the cavities. The second wing leans against the top surface.

Preferably, an edge of the top surface is recessed downwardly by a first height to form a notch. An edge of the bottom surface projects downwardly by a second height to form a retaining wall. The second height is greater than the sum of the first height and the distance.

### BRIEF DESCRIPTION OF THE DRAWINGS

FIG. 1 is a perspective view of a first embodiment the planting cup of the present invention;

FIG. 2 is another perspective view of the first embodiment the planting cup of the present invention;

FIG. 3 is a schematic view of the first embodiment of the planting cup of the present invention placed on the planting tray;

FIG. 4 is a schematic view of the first embodiment of the planting cup used for planting of the present invention;

FIG. 5 is a perspective view of a second embodiment of the planting cup of the present invention;

FIG. 6 is a perspective view of a third embodiment of the planting cup of the present invention;

FIG. 7 is a sectional view of the planting device of the present invention;

FIG. 8 is a perspective view of the planting tray of the present invention; and

FIG. 9 is a sectional view of the planting tray of the present invention.

### DESCRIPTION OF THE PREFERRED EMBODIMENTS

Advantages and features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein. In the drawings, the relative sizes of elements should not be construed as being limited to the proportion and arrangement relationship as shown in the drawings and may be exaggerated for clarity, without departing from the spirit and scope of the present invention.

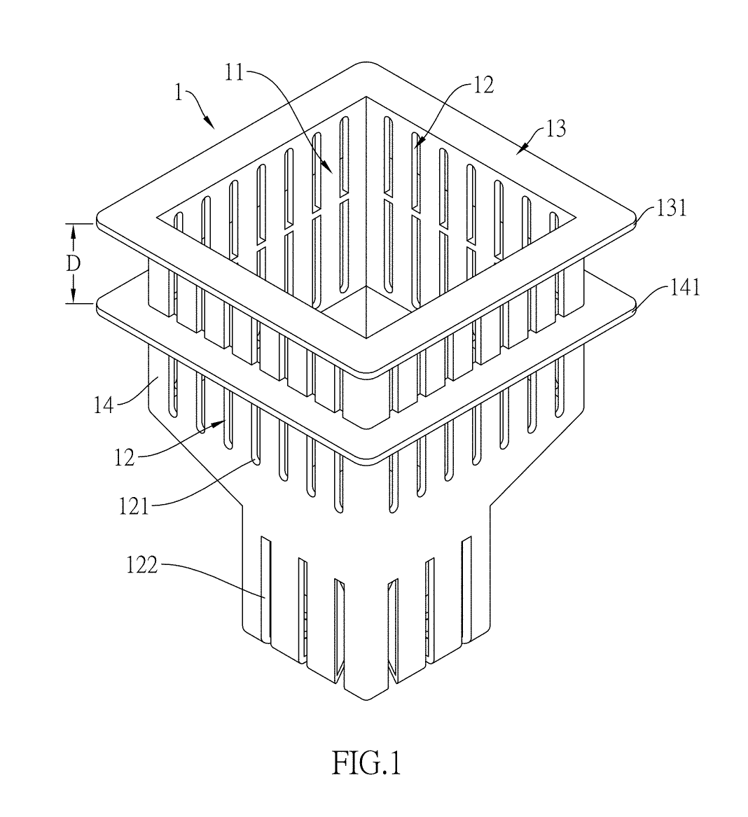

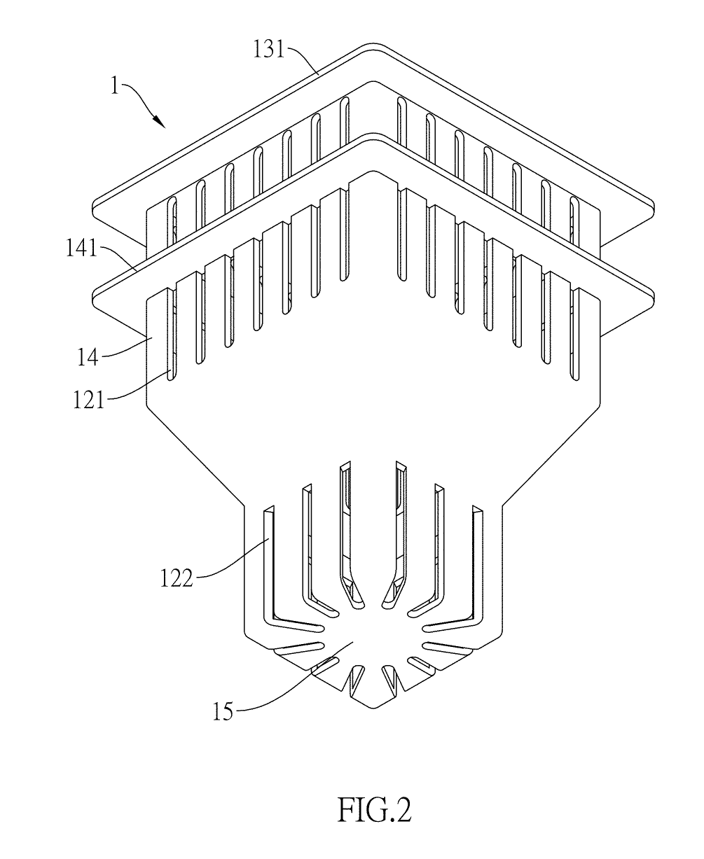

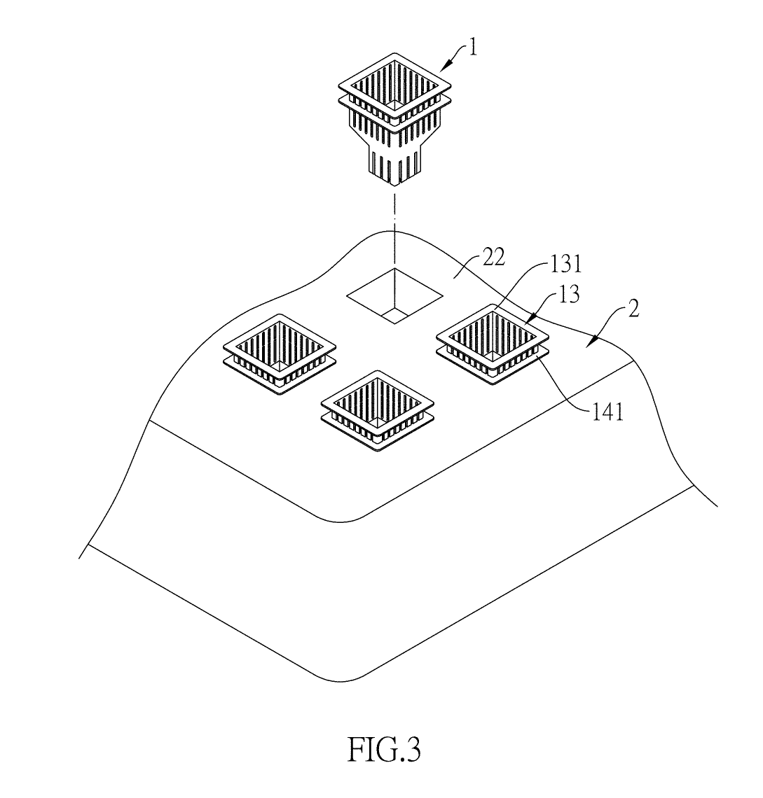

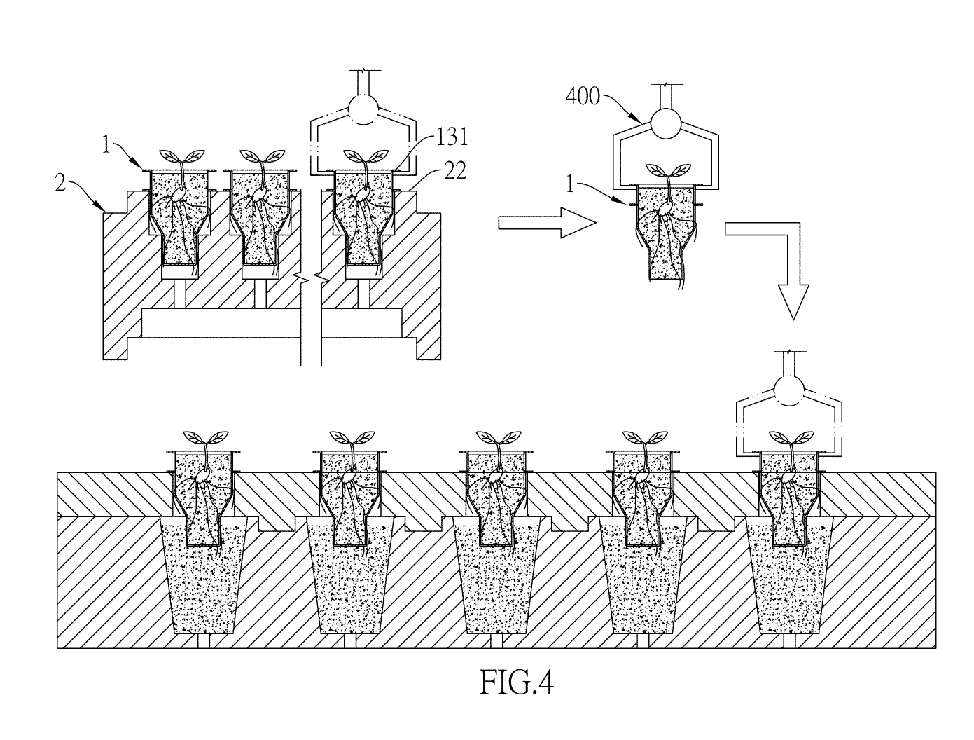

Referring to FIG. 1 to FIG. 4, the present invention discloses a planting cup 1. The planting cup 1 is a hollow cup body. The planting cup 1 comprises a side portion 14, a bottom portion 15, a top portion 13, and an accommodation space 15 surrounded by the side portion 14, the bottom portion 15, and the top portion 13. The bottom portion 15 and the side portion 14 each have a plurality of through holes 12. The top portion 13 is formed with a first wing 131 extending laterally outwardly. The side portion 14 is formed with a second wing 141 extending laterally outwardly. The first wing 131 is spaced from the second wing 141 by a distance D. The accommodation space 11 is configured to receive soil, plant seeds or plants for cultivating plants. When the planting cup 1 of the present invention is placed on a planting tray 2, the second wing 141 abuts against a top surface 22 of a planting tray 2 so that the first wing 131 is higher than the top surface 22 by at least the height of the distance D. This is beneficial for a robot arm 400 or a user's finger to grasp the first wing 131 for removing the planting cup 1, avoiding touching the top surface 22. The distance D is configured to receive the robot arm 400 or the user's finger, such that the top surface 22 won't be damaged by the robot arm 400 or the robot arm 400 won't be restricted by the top surface 22 to lose the accuracy of grasping the planting cup 1. Of course, it can avoid an injury to the user's finger. The design of this distance D may increase the efficiency and accuracy of grasping the gripping cup 1 to prevent the top surface 22 from being damaged, and can avoid an injury to the user's finger.

In a preferred embodiment, the side portion 14, the bottom portion 15, the first wing 131 and the second wing 141 are integrally formed. The planting cup 1 may be formed by injection molding, thereby increasing the efficiency of manufacture and reduces the manufacturing cost. Besides, the overall strength of the planting cup 1 is optimal.

In addition, the cross-sectional area of the upper half of the side portion 14 is equal to the cross-sectional area of the lower half of the side portion 14, or the cross-sectional area of the upper half of the side portion 14 is greater than the cross-sectional area of the lower half of the side portion 14. In a preferred embodiment, the cross-sectional area of the upper half of the side portion 14 is greater than the cross-sectional area of the lower half of the side portion 14. Such a design is to reduce the quantity of the soil used in the lower half of the side portion 14 in order to save the cost of soil.

Furthermore, the side portion 14 is provided with a plurality of first through holes 121 between the first wing 131 and the second wing 141, and the side portion 14 is provided with a plurality of second through holes 122 between the second wing 141 and the bottom portion 15. The number or the total area of the first through holes 121 is equal to the number or the total area of the second through holes 122, or the number or the total area of the first through holes 121 is greater than the number or the total area of the second through holes 122. In a preferred embodiment, the number or the total area of the first through holes 121 is greater than the number or the total area of the second through holes 122. Thereby, when the accommodation space 11 filled with soil, plant seeds or plants is watered, the water will flow down, so that the first through holes 121 greater in number or in total area achieve the effect of better water permeability, and the second through holes 122 less in number or in total area achieve the effect of good water retention.

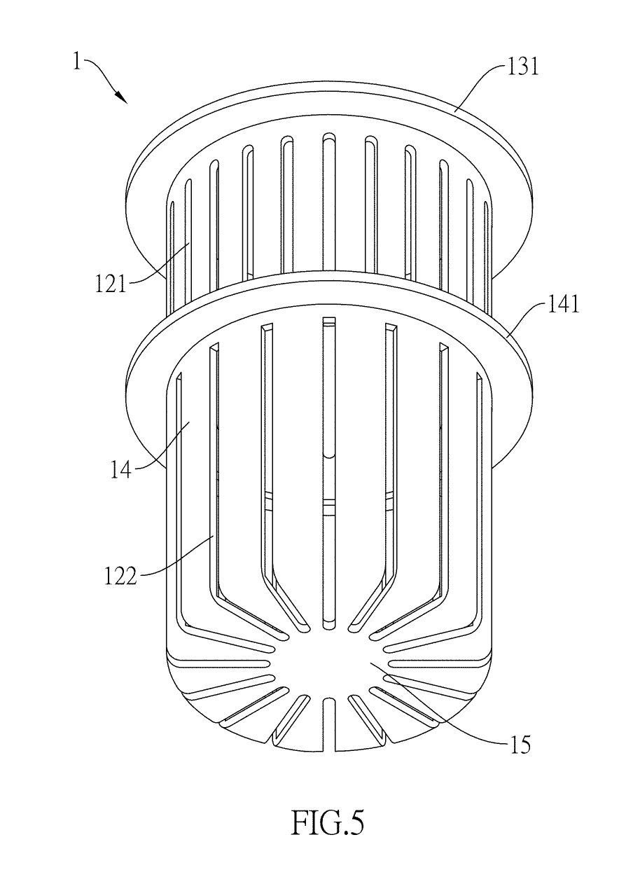

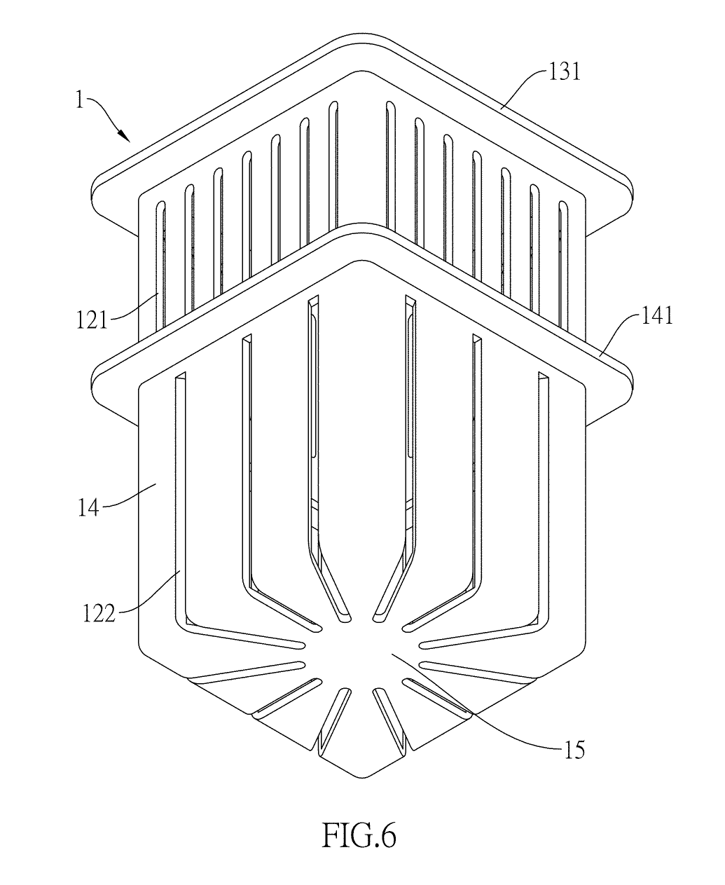

In a specific implementation, the shape of the planting cup 1 may be changed according to the specific demand to be used in a specific situation. Referring to FIG. 5 and FIG. 6, the planting cup 1 may be a hollow cylinder or a hollow cuboid. Of course, it may be a hollow cube. As shown in FIG. 5, the planting cup 1 is in the form of a hollow cylinder. The cross-section of the side portion 14 is circular. The side portion 14 is provided with a plurality of first through holes 121 between the first wing 131 and the second wing 141, and the side portion 14 is provided with a plurality of second through holes 122 between the second wing 141 and the bottom portion 15. The number of the first through holes 121 is greater than the number of the second through holes 122. As shown in FIG. 6, the planting cup 1 is in the form of a hollow cuboid. The cross-section of the side portion 14 is rectangular. The side portion 14 is provided with a plurality of first through holes 121 between the first wing 131 and the second wing 141, and the side portion 14 is provided with a plurality of second through holes 122 between the second wing 141 and the bottom portion 15. The number of the first through holes 121 is greater than the number of the second through holes 122. In addition, it is worth mentioning that the strength of the side portion 14 is enhanced by the design of the second wing 141, so that the planting cup 1 is resistant to a destructive force in a transverse direction, such as, an accidental collision.

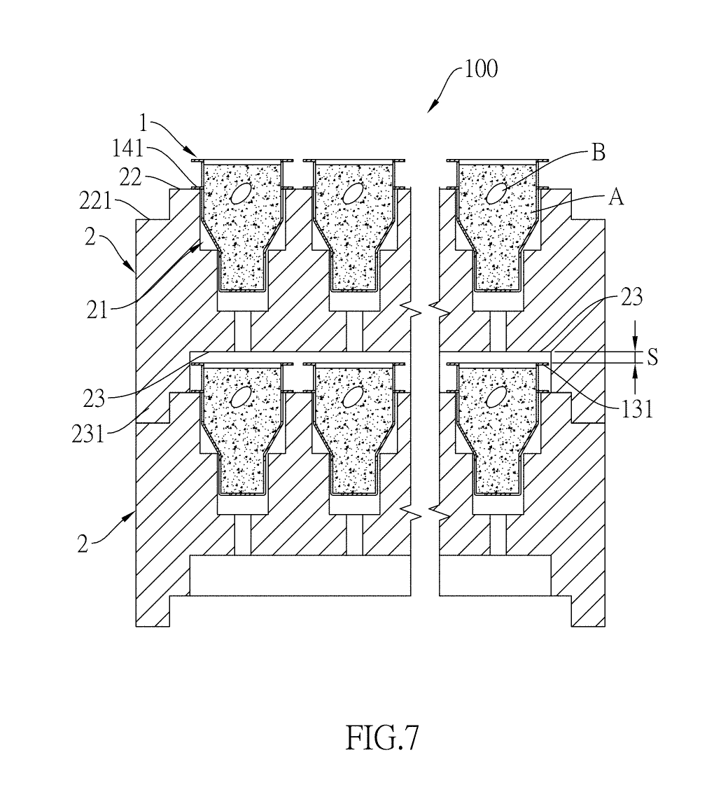

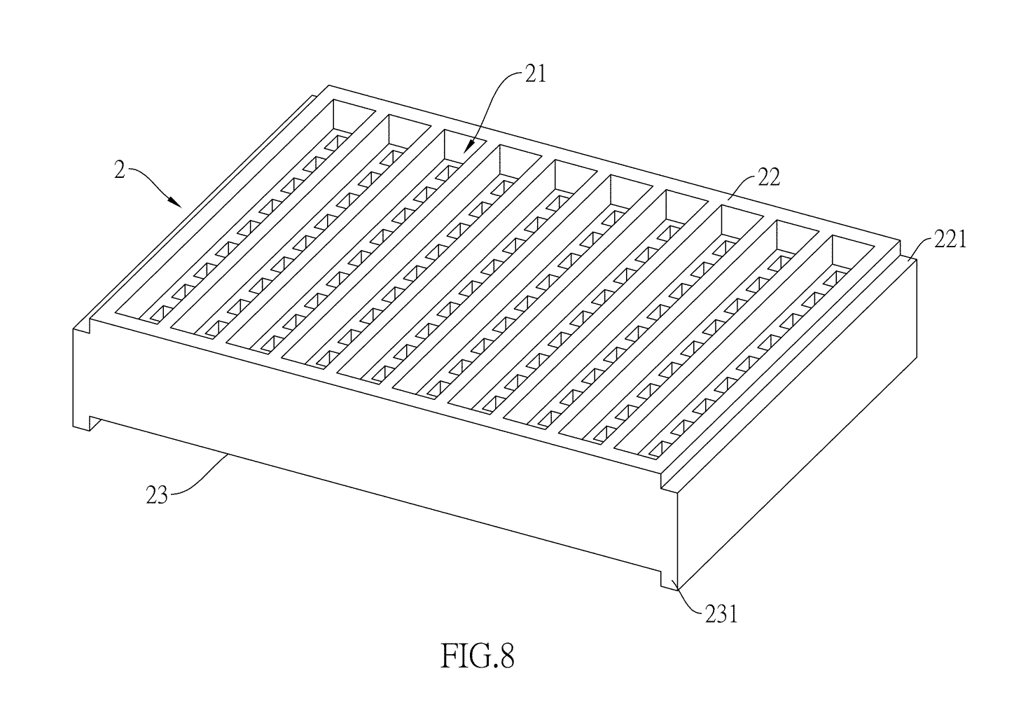

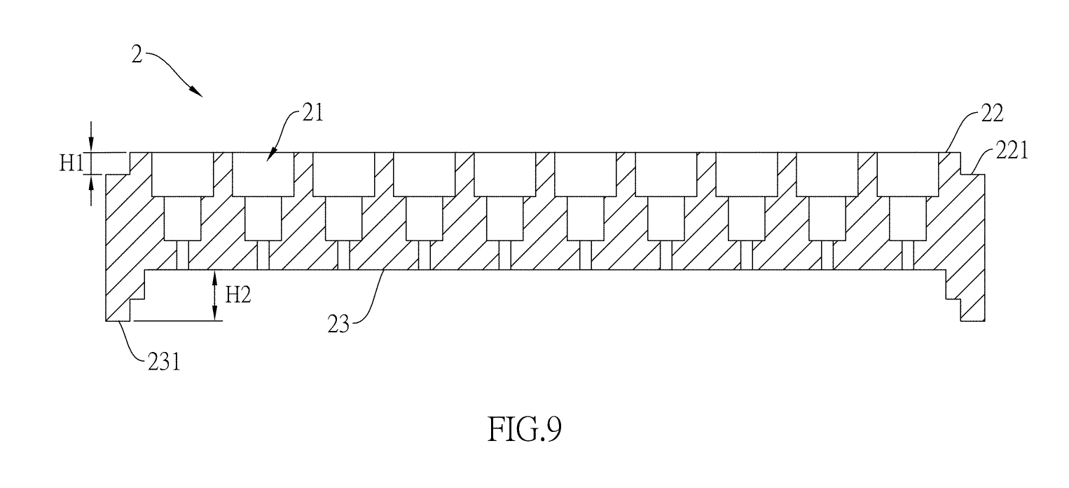

As shown in FIG. 7 to FIG. 9, a planting device 100 of the present invention comprises at least one planting cup 1 and the planting tray 2 as described above. The planting tray 2 has a plurality of spaced cavities 21 penetrating the top surface 22 and a bottom surface 23 of the planting tray 2. The planting cup 1 is placed in one of the cavities 21, and the second wing 141 leans against the top surface 22. The planting tray 2 is mainly used at the stage of seedling growth for placement of the planting cup 1. Soil A and seeds B are placed in the planting cup 1 manually or in an automatic control manner to be watered. The edge of the top surface 22 is recessed downwardly by a first height H1 to form a notch 221. The edge of the bottom surface 23 projects downwardly by a second height H2 to form a retaining wall 231. The second height H2 is greater than the sum of the first height H1 and the distance D. When a plurality of planting trays 2 or a plurality of planting device 100 are stacked, the retaining wall 231 leans against the notch 221 of another planting tray 2, thereby saving the space. The second height H2 is greater than the sum of the first height H1 and the distance D, which is represented by H2>(H1 +D) in the form of a mathematical formula. Since the second height H2 is greater than the sum of the first height H1 and the distance D, a gap S is formed between the bottom surface 23 and the first wing 131 of the planting cup 1 of another planting device 100 as a growing space for germination into the plant.

In particular, the planting cup of the present invention is provided with two wings. The second wing located below can lean against the top of the planting tray, and the first wing located at the upper end of the planting cup is adapted for grasping by a mechanical device or by manpower, such that the cultivation of seedling can be carried out conveniently and consistently to save time and labor and to improve the working efficiency.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A planting cup, comprising a side portion, a bottom portion, a top portion, and an accommodation space surrounded by the side portion, the bottom portion, and the top portion; the bottom portion and the side portion each having a plurality of through holes, the top portion being formed with a first wing extending laterally outwardly, the side portion being formed with a second wing extending laterally outwardly, the first wing being spaced from the second wing by a distance.

2. The planting cup as claimed in claim 1, wherein the side portion, the bottom portion, the first wing and the second wing are integrally formed.

3. The planting cup as claimed in claim 1, wherein the side portion is provided with a plurality of first through holes between the first wing and the second wing, the side portion is provided with a plurality of second through holes between the second wing and the bottom portion, the number or the total area of the first through holes is equal to the number or the total area of the second through holes.

4. The planting cup as claimed in claim 1, wherein the side portion is provided with a plurality of first through holes between the first wing and the second wing, the side portion is provided with a plurality of second through holes between the second wing and the bottom portion, the number or the total area of the first through holes is greater than the number or the total area of the second through holes.

5. The planting cup as claimed in claim 1, wherein the cross-sectional area of an upper half of the side portion is equal to the cross-sectional area of a lower half of the side portion.

6. The planting cup as claimed in claim 1, wherein the cross-sectional area of an upper half of the side portion is greater than the cross-sectional area of a lower half of the side portion.

7. The planting cup as claimed in claim 1, wherein the planting cup is one of a hollow cylinder and a hollow cuboid.

8. The planting cup as claimed in claim 2, wherein the side portion is provided with a plurality of first through holes between the first wing and the second wing, the side portion is provided with a plurality of second through holes between the second wing and the bottom portion, the number of the first through holes is greater than the number of the second through holes, and the planting cup is one of a hollow cylinder and a hollow cuboid.

9. A planting device, comprising at least one planting cup as claimed in claim 1 and a planting tray; the planting tray having a plurality of spaced cavities penetrating a top surface and a bottom surface of the planting tray, the planting cup being placed in one of the cavities, the second wing leaning against the top surface.

10. The planting device as claimed in clam 9, wherein an edge of the top surface is recessed downwardly by a first height to form a notch, an edge of the bottom surface projects downwardly by a second height to form a retaining wall, and the second height is greater than the sum of the first height and the distance.
